(19) United States
(12) Patent Application Publication
(10) Pub. No.: US 2026/0208423 A1
(43) Pub. Date: Jul. 23, 2026

(54) MINIATURIZED VOLUMETRIC EXTRUDER USING TWIN CONICAL SCREWS, EACH PROVIDED WITH A THREAD, THE PITCH OF WHICH INCREASES TO MAINTAIN A CONSTANT DISPLACEMENT

(71) Applicant: COMPAGNIE GENERALE DES ETABLISSEMENTS MICHELIN, Clermont-Ferrand (FR)

(72) Inventor: Christophe HOMBERT, Clermont-Ferrand (FR)

(73) Assignee: COMPAGNIE GENERALE DES ETABLISSEMENTS MICHELIN, Clermont-Ferrand (FR)

(21) Appl. No.: 19/141,531

(22) PCT Filed: Dec. 13, 2023
(86) PCT No.: PCT/EP2023/085560

§ 371 Date: Jun. 20, 2025

(30) Foreign Application Priority Data
Dec. 23, 2022 (FR) 2214370

(51) Int. Cl. B29C 48/525; B29C 48/41; B29C 48/535; B29C 48/54; B29C 48/63; B29C 48/645

(52) U.S. Cl. CPC B29C 48/525; B29C 48/41; B29C 48/535; B29C 48/54; B29C 48/63; B29C 48/645

(57) ABSTRACT

The extruder has a first conical screw and a second conical screw, which are counter-rotatably mounted in a barrel. The first and second conical screws define a volumetric stage within which the threads are interpenetrating and are conjugated with respect to one another in such a way as to form, between the barrel and the screws, a succession of C-shaped closed chambers. This gives the extruder volumetric operation and, in at least part of the volumetric stage, the pitch of the thread of the screws increases according to a predetermined law of compensation, preferably quadratic, so that the successive closed chambers each have an individual volume that remains equal to a predetermined constant volume forming the displacement of the screw in question.

### CROSS-REFERENCE TO RELATED APPLICATION

This application claims priority to and the benefit of PCT Patent Application No. PCT/EP2023/085560 filed on 13 Dec. 2023, entitled “MINIATURIZED VOLUMETRIC EXTRUDER USING TWIN CONICAL SCREWS, EACH PROVIDED WITH A THREAD, THE PITCH OF WHICH INCREASES TO MAINTAIN A CONSTANT DISPLACEMENT”, and French Patent Application No. FR 2214370, filed on 23 Dec. 2022, entitled “MINIATURIZED VOLUMETRIC EXTRUDER USING TWIN CONICAL SCREWS, EACH PROVIDED WITH A THREAD, THE PITCH OF WHICH INCREASES TO MAINTAIN A CONSTANT DISPLACEMENT”.

### BACKGROUND

### 1. Field

The present disclosure relates to the general field of extrusion, and more particularly to the field of extrusion of rubber-based materials.

The present disclosure is particularly applicable to the manufacture of elements intended to be used when making tires for vehicle wheels.

### 2. Related Art

It is known that extrusion operations generally require precise control of the flow rate of the extruded material, to avoid the production of non-compliant products, and therefore scrapping of the products.

However, in practice, it is sometimes difficult to ensure such precise control of the flow rate of the extruded material during transient phases of the extrusion process, such as extrusion line start-up, stop-down and restart phases. This difficulty is due in particular to the fact that, during such transient phases, the temperature of the extrusion tools on the one hand, and the speed of the moving mechanical parts of the extruder(s) on the other hand, are not stabilized, which gives rise to variations in the rheological properties and behavior of the extruded material.

To ensure control of the flow rate of the extruded material, it is known practice to put in place what are known as “volumetric” extruders, in other words extruders which are provided with moving mechanical parts, such as pistons, gear wheels or interpenetrating twin screws, which are arranged in such a way as to create, within the extruder, one or more chambers which will, under the effect of the cyclical movement of the moving mechanical parts, first open and increase their volume to accommodate the incoming material, then close so as to capture a given quantity of the material, and lastly contract to mechanically force the captured quantity of material out of the chamber.

Thus, such extruders are capable of delivering, whatever the pressure prevailing at the outlet of the extruder, a volume of extruded material, referred to as the “displacement” of the extruder, which is constant for each new iteration of the cyclical operation of the extruder, that is, in the example above, a volume of extruded material which is identical with each return stroke of the piston, respectively with each revolution of the gear wheels, or with each revolution of the twin screws.

The facilities which use such volumetric extruders also often have a multi-stage structure, each stage being formed by an extruder of a chosen type, in order to be able to perform all of the functions involved in the supply of material to the facility, the plasticization of the material, the increase in pressure of the material, then the volumetric dispensing of the material at the outlet of the facility.

Thus, for example, it is known practice to combine in series, within the same facility, a single-screw extruder, of Archimedes screw type, on the one hand, which comprises a screw rotatably mounted in a sheath and which ensures the supply, plasticization, and a certain increase in pressure and temperature of the material by shearing, with on the other hand a gear pump, the inlet port of which is connected to the discharge port of the single-screw extruder, and the counter-rotating gear wheels of which ensure, in collaboration with the casing of the gear pump, the final increase in pressure and the volumetric operation of the facility.

However, such facilities are particularly bulky and cumbersome.

This is especially true when these facilities are intended to extrude a rubber-based material. To be specific, so as not to impair the rubber-based material, it is necessary to avoid exposing this material to excessively high temperatures, which means not rotating the gear pump wheels at too high a speed. Therefore, if it is desired to ensure a sufficient flow rate of extruded material, it is necessary to opt for a gear pump which has a large displacement, and therefore large dimensions.

Co-extrusion facilities are also known, such as that described in patent application WO 2017/109419 filed by the applicant, in which a first stage formed by a feed screw supplies a second stage comprising interpenetrating and conjugated twin screws which ensure the volumetric operation. Although such an arrangement advantageously makes it possible to multiply the number of extrusion paths connected to the same extrusion head while still having a relatively compact extrusion head, and to guarantee a relatively high and well-controlled flow rate of each of the extruded materials, facilities of this type are nevertheless designed for co-extrusion applications which aim to produce complex profiles combining numerous extruded materials, and have, overall, owing to the multiplicity of extrusion paths, a relatively large bulk.

Furthermore, known facilities can be relatively expensive, not only to acquire but also to operate, particularly owing to their energy consumption and their complex maintenance requirements.

### SUMMARY

The objectives of the disclosure therefore aim to overcome the aforementioned drawbacks and to propose a miniaturized extruder which has a reduced bulk and weight while maintaining satisfactory volumetric operation which allows excellent control of the flow rate of the extruded material.

The objectives of the disclosure are achieved by means of an extruder intended to extrude a material, the extruder comprising:
a barrel,
a first screw which is rotatably mounted in the barrel about a first central axis and which is provided with a first thread,
a second screw which is rotatably mounted in the barrel about a second central axis and which is provided with a second thread, the first screw and second screw being counter-rotating and arranged such that the first thread and the second thread interact to convey the material from upstream to downstream in the barrel, wherein:
the first screw is conical, such that the crest diameter of the first thread decreases along the first central axis, in the upstream-downstream direction, according to a first predetermined angle of conicity,
the second screw is conical, such that the crest diameter of the second thread decreases along the second central axis, in the upstream-downstream direction, according to a second predetermined angle of conicity,
wherein the extruder comprises a stage referred to as the “volumetric stage” within which the first thread of the first screw and the second thread of the second screw are interpenetrating and conjugated with respect to one another in such a way as to form, on the one hand, between the barrel and the first screw, along the first central axis, a first series of successive C-shaped closed chambers and, on the other hand, between the barrel and the second screw, along the second central axis, a second series of successive C-shaped closed chambers, so that the rotation of the first and second screws generates a positive displacement of the material captured by the first series of chambers and of the material captured by the second series of chambers, and
wherein at least part of the volumetric stage forms a stage referred to as the “isochoric volumetric stage”, within which:
the pitch of the first thread increases along the first central axis, in the upstream-downstream direction, as the crest diameter of the first thread decreases, according to a law referred to as the “first law of compensation” which allows the progressive increase in the pitch of the first thread to compensate for the conicity of the first screw so that, in the isochoric volumetric stage, the individual volume of each of the closed chambers of the first series of closed chambers remains equal to the same predetermined constant nominal volume, referred to as the “first screw displacement”, with a maximum tolerance of +/−2%, preferably +/−1%, or even +/−0.5%, and
the pitch of the second thread increases along the second central axis, in the upstream-downstream direction, as the crest diameter of the second thread decreases, according to a law referred to as the “second law of compensation” which allows the progressive increase in the pitch of the second thread to compensate for the conicity of the second screw so that, in the isochoric volumetric stage, the individual volume of each of the closed chambers of the second series of closed chambers remains equal to the same predetermined constant nominal volume, referred to as the “second screw displacement”, with a maximum tolerance of +/−2%, preferably +/−1%, or even +/−0.5%.

Advantageously, the extruder according to the disclosure can alone ensure the plasticization of the material, the increase in pressure, and volumetric operation at the precisely controlled flow rate, all while taking up relatively little space.

The arrangement of the threads according to the disclosure, the pitch of which increases, in the isochoric volumetric stage, as the cone of the screw narrows, advantageously makes it possible to reconcile the conicity of the screws with the constancy of the volume of each closed chamber while the chamber progresses from upstream to downstream along the central axis of the screw, as the screw rotates on itself. Thus, the volume of extruded material that is captured by the chamber that opens at the upstream inlet of the isochoric volumetric stage is the same captive unit volume transported by each closed chamber of the isochoric volumetric stage that is between the screw and the barrel, and the same volume that is discharged by the chamber that opens at the downstream end of the isochoric volumetric stage. This constant unit volume advantageously corresponds to the volume of extruded material that is expelled on each complete revolution of the screw in question, in other words the displacement of the screw.

Since, at each given instant, the volume of the various closed chambers defined along its central axis by the same conical screw is constant, or quasi-constant taking into account the aforementioned admissible tolerances, in other words the volume is neither reduced nor increased substantially, whatever the position that the closed chamber in question occupies along the axis, the material contained in the closed chambers is conveyed regularly, along the central axis of each screw, from upstream to downstream of the extruder.

This ensures volumetric operation of each conical screw while preventing in particular problems of local excess pressure and therefore problems of leakage between the successive chambers of the same screw, which could occur if the captive material in a closed chamber were excessively compressed by seeking to reduce the volume of the chamber without giving the material the possibility of escaping, or problems in terms of local pressure drop and cavitation, which could occur if there was a tendency to generate an expansion of the captive material in a closed chamber by increasing the volume of the chamber, that is to say by increasing the volume accessible to the material, without increasing the quantity of material available in the chamber.

In this regard, note that, as will be seen below, it is advantageous to associate with the volumetric stage, upstream of the volumetric stage and within the same first and second screws, a feed stage which will make it possible to work and compress the material in order to ensure feeding of the volumetric stage.

The conicity of the screws has several advantages.

A first advantage of the conicity is that the upstream portion of the screw, which corresponds to the large base of the frustoconical envelope in which the screw is inscribed, has a large diameter and therefore offers wide access for the introduction of the material into the extruder, which provides good conditions for performance of the feeding function.

A second advantage of the conicity is that the projected area of the thread, considered in a plane normal to the central axis of the screw, decreases along the axis, such that the projected area is minimal at the downstream end of the conical screw, which corresponds to the small base of the frustoconical cone envelope in which the screw is inscribed. Thus, the projected area of the thread is minimal precisely in the zone where the material exerts the highest pressure against the screw, necessary to overcome the pressure prevailing at the outlet of the extruder and to propel the material through the extrusion die connected to the outlet of the extruder. Minimizing the area of the projected area that is subjected to the pressure exerted on the screw by the material subjected to the action of the extruder reduces the resulting axial force exerted by the material against the screw and the bearings that support the screw and allow it to rotate inside the barrel. Therefore, it will be possible to safely reduce the size of these bearings, thus making the extruder more compact and lightweight.

A third advantage of the conicity is that it reduces the wetted area of the screw, that is, the area of the screw that is in contact with the material, compared to what this same wetted area would be within a straight cylindrical screw with a constant diameter and an axial length equal to the length of the conical screw. Reducing the wetted area, along with the lever arm which corresponds, at each point of the wetted area, to the radial distance measured between the central axis of the screw and the given point, reduces the resistance torque exerted by the material, owing to its viscosity, against the rotation of the screw. An extruder according to the disclosure therefore requires a relatively low driving torque, which makes it possible to reduce the size, as well as the weight, of the motor(s) and the reduction gear(s) which rotate the first and second screws.

For all of these reasons, the disclosure advantageously makes it possible to implement a compact, lightweight extruder that is relatively unaffected by mechanical inertia, thermal inertia, and vibration.

Advantageously, because it is lightweight and compact, such an extruder may be mounted on a transport device which makes it possible to move and position the extruder dynamically relative to a receiving support on which the desired object is constructed, which makes it possible to produce the object by three-dimensional printing by depositing the extruded material on the receiving support at the desired locations and in the desired quantities.

### BRIEF DESCRIPTION OF THE DRAWINGS

Further aims, features and advantages of the disclosure will become apparent in more detail on reading the following description and with the aid of the appended drawings, which are provided purely by way of non-limiting illustration, and in which:

FIG. 1 shows, in a perspective view, a pair of first and second counter-rotating twin screws according to a first variant of the disclosure, in which the volumetric stage is preceded by a feed stage in which each of the first and second screws is single-threaded.

FIG. 2 is a top detail view of one screw of the pair of screws in FIG. 1.

FIG. 3 shows, in a perspective view, a pair of first and second counter-rotating twin screws according to a second variant of the disclosure, in which the volumetric stage is preceded by a feed stage in which each of the first and second screws is double-threaded.

FIG. 4 is a top view of one screw of the pair of screws in FIG. 3.

FIG. 5 shows, in a perspective detail view, the isochoric volumetric stage of a pair of counter-rotating twin conical screws used in an extruder according to the disclosure, for example the pair of screws in FIG. 1 or the pair in FIG. 3.

FIG. 6 is a top view of the pair of screws in FIG. 5.

FIG. 7 is an end-on view, from downstream, of the pair of screws in FIGS. 5 and 6.

FIG. 8 is a view in cross section, in a plane containing the first central axis of the first screw and the second central axis of the second conical screw, of the isochoric volumetric stage of an extruder according to the disclosure, within which the screws in FIGS. 5 to 7 interact with a barrel to form two series of C-shaped closed chambers.

FIG. 9 is a perspective view of the volumes defined, along the first central axis, by the first closed chamber and the last closed chamber of the first series of C-shaped closed chambers of the volumetric stage, and more particularly of the isochoric volumetric stage, of an extruder according to the disclosure.

FIG. 10 shows, superimposed on the chambers in FIG. 9, on the one hand the fictitious external frustoconical envelope inside which the crest of the first thread is inscribed, and which therefore corresponds to the overall frustoconical envelope of the first screw, and on the other hand the fictitious internal frustoconical envelope which is inscribed in the root of the first thread, and which therefore corresponds to the frustoconical envelope of the core of the first screw, in the isochoric volumetric stage.

FIG. 11 is a top view of the chambers shown in FIGS. 9 and 10, and of the fictitious external frustoconical envelope.

FIG. 12 is a side view, from upstream of the screw, of the chambers shown in FIGS. 9 to 11.

FIG. 13 shows, in a view laid out in a reference plane which is, by convention, normal to the first central axis and tangent to the upstream axial end of the isochoric volumetric stage of the first conical screw, a principle of dimensioning of the isochoric stage of the first conical screw.

FIG. 14 is an example of an extrusion facility implementing a mobile laying head which carries an extruder with twin conical screws according to the disclosure.

FIG. 15 is an example of dimensioning laws for the thread of a conical screw used by the disclosure, in this case in preferential connection with the first variant shown in FIGS. 1 and 2, depicting the quadratic increase in the thread pitch in the isochoric volumetric stage, and the reduction in the thread in the feed stage which precedes the isochoric volumetric stage.

### DETAILED DESCRIPTION OF THE ENABLING EMBODIMENT

The present disclosure relates to an extruder 1, intended for extruding a material, and more particularly an extruder 1 of “twin-screw” type.

The extruder comprises, in a manner known per se, a barrel 4, preferably made of metal.

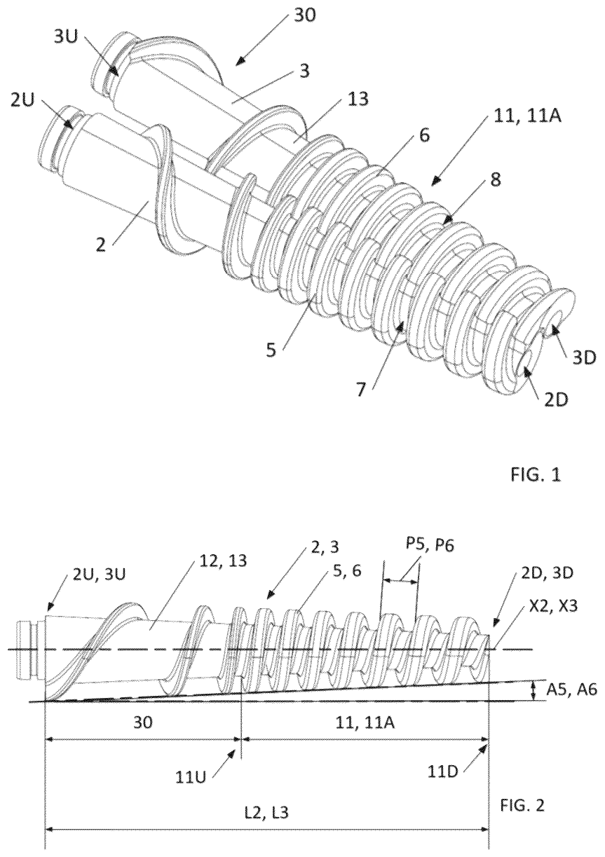

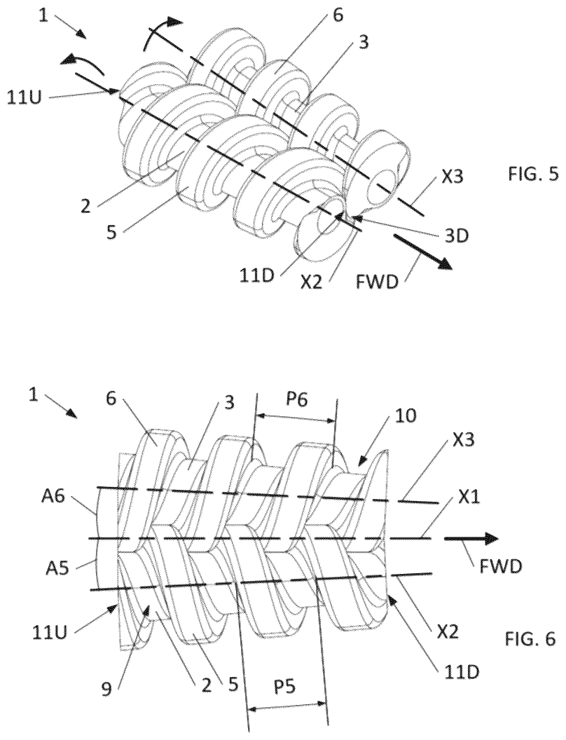

As can be clearly seen in FIGS. 1 to 8, the extruder 1 comprises: —a first screw 2 which is rotatably mounted in the barrel 4 about a first central axis X2 and which is provided with a first thread 5,
a second screw 3 which is rotatably mounted in the barrel 4 about a second central axis X3 and which is provided with a second thread 6.

The first and second screws 2, 3 are counter-rotating and arranged such that the first thread 5 and the second thread 6 interact to convey the material from upstream to downstream in the barrel 4, with an overall forward movement denoted “FWD” here.

For convenience in the description, “axial” will denote a direction parallel to the central axis X2, X3 of the screw 2, 3 in question, and “radial” will denote a direction perpendicular to the central axis X2, X3 of the screw 2, 3 in question.

Note that the first central axis X2 and the second central axis X3 are geometrically intersecting.

“Counter-rotating” means that the first screw 2 and the second screw 3 rotate in opposite directions of rotation.

Furthermore, the first and second screws 2, 3 are synchronous, that is to say advantageously rotate at rotation speeds which are equal to one another in absolute value, although of opposite signs.

The first thread 5 may, in particular depending on the stage of the first screw 2 considered along the first central axis X2, comprise a single screw thread, or, as a variant, several screw threads having the same pitch and offset angularly.

The term “first channel” 9 denotes the helical groove, or, in the case of a plurality of screw threads, each of the helical grooves, which is delimited by and between two solid profiles of the first thread 5 which follow one another axially, that is to say which separates two solid profiles of the first thread 5, one of which is immediately next to the other.

Likewise, the second thread 6 may, depending on the stage of the second screw 3 considered along the second central axis X3, comprise one or more screw threads, preferably equal in number to the number of screw thread(s) of the first thread 5 with which the second thread 6 interacts.

The term “second channel” 10 denotes the helical groove, or, in the case of a plurality of screw threads, each of the helical grooves, which is delimited by and between two solid profiles of the second thread 6 which follow one another axially, that is to say which separates two solid profiles of the second thread 6, one of which is immediately next to the other.

The direction of the first thread 5 will be opposite to the direction of the second thread 6, in other words the first screw 2 may have a left-hand thread 5 while the second screw 3 has a right-hand thread 6, or conversely, the first screw 2 may have a right-hand thread 5 while the second screw 3 has a left-hand thread 6.

More generally, the second screw 3 is preferably the mirror image of the first screw 2, such that the characteristics of one can be deduced identically, by symmetry, from the characteristics of the other.

According to the disclosure, the first screw 2 is conical, such that the crest diameter D_5C of the first thread 5 decreases along the first central axis X2, in the upstream-downstream direction, according to a first predetermined angle of conicity A5.

Likewise, the second screw 3 is conical, such that the crest diameter D_6C of the second thread 6 decreases along the second central axis X3, in the upstream-downstream direction, according to a second predetermined angle of conicity A6.

As can be seen in FIGS. 2, 4, 6, 8 and 11, the angle of conicity A5, A6 corresponds to the angle of inclination formed, in a plane containing the central axis X2, X3 of the screw 2, 3 in question, by the fictitious frustoconical envelope E2, E3 in which the screw 2, 3 is inscribed, the frustoconical envelope E2, E3 therefore being tangent to the successive crests 5C, 6C of the thread 5, 6 of the screw 2, 3 in question, relative to the fictitious right cylinder with a circular base, centred on the central axis X2, X3, and in which the screw 2, 3 in question is inscribed.

Equivalently, the angle of conicity A5, A6 corresponds to the half-angle at the apex of the fictitious frustoconical envelope E2, E3 in which the screw 2, 3 in question is inscribed, and therefore to the angle formed between the central axis X2, X3 and each generatrix line of the inclined wall of the fictitious frustoconical envelope E2, E3 in which the screw 2, 3 is inscribed.

In practice, the first angle of conicity A5 is equal to the second angle of conicity A6.

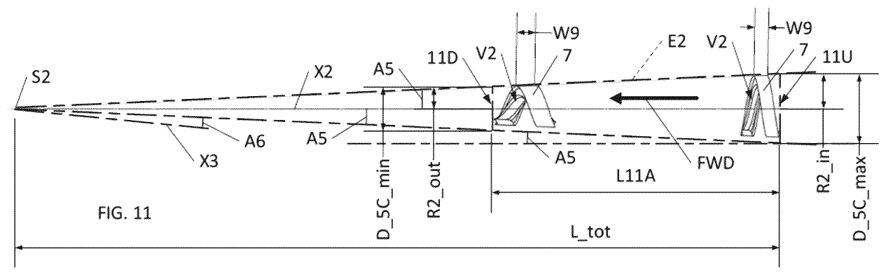

More particularly, since the first central axis X2 and the second central axis X3 are geometrically intersecting, the first angle of conicity A5 and the second angle of conicity A6 are each equal to half the angle at the apex formed by the intersection of the first central axis X2 and the second central axis X3, as can be seen in FIG. 11.

Naturally, the inner wall of the barrel 4, which interacts with one of the screws 2, 3, also has a conical profile, matching the conical profile of the screw 2, 3, that is to say which generally follows the same fictitious frustoconical envelope, being circumscribed to the frustoconical envelope E2, E3. The inner wall of the barrel 4 therefore generally narrows in the direction moving through the barrel 4 in the upstream-downstream direction FWD, at the same angle of conicity A5, A6 as the screw 2, 3.

Preferably, the first angle of conicity A5 and the second angle of conicity A6 are each between 1.8 degrees and 3 degrees, preferably between 2 degrees and 2.5 degrees, even more preferably equal to 2.5 degrees.

The inventors have in fact found that, for a given screw length, and therefore for a given bulk, these angle of conicity values correspond to a good compromise between, on the one hand, the resistant forces exerted on the screw 2, 3, which it is desired to minimize, and on the other hand the capacity of the screws to receive and be able to exploit a relatively high driving torque.

In Particular, an Optimal Compromise Will be Sought Between:
an angle of conicity A5, A6 which is sufficiently high
i) to obtain a significant reduction in the terminal surface of the screw 2, 3, which corresponds to the small base of the frustoconical envelope E2, E3 in which the screw 2, 3 is inscribed, and consequently to obtain a significant reduction in the axial forces which result from the pressure exerted by the extruded material against the screw 2, 3 in question, which makes it possible to reduce the size of the bearings and axial stops which axially support the screw 2, 3, and
ii) to create a sufficient centre distance, between the first screw 2 and the second screw 3, in the upstream zone 2U, 3U of the screws 2, 3, to be able to have sufficient space to house therein a solid and powerful reduction gear as well as large-diameter shafts capable of driving the screws 2, 3 and of imparting to each of them a high driving torque, and
an angle of conicity A5, A6 which is sufficiently moderate
i) so that the diameter of the screw 2, 3 in the upstream zone 2U, 3U remains sufficiently small to avoid offering the extruded material a strong lever arm relative to the central axis X2, X3 of the screw, and therefore limit the resistance torque that the extruded material opposes to the rotation of the screw 2, 3, and
ii) so as not to over-thin the screws 2, 3 at their tip, that is to say so that the cores of the first screw 2 and of the second screw 3 have, up to and including at the downstream end 2D, 3D of the screws 2, 3, a thickness of material sufficient to be able to support and transmit without damage, in particular without irreversible deformation in torsion, a high driving torque.

In view of the abovementioned angle of conicity values A5, A6, the angle at the apex formed by the (fictitious) intersection of the first central axis X2 with the second central axis X3, which is equal to the sum of the two apex angles A5 and A6, and therefore more preferably twice the apex angle A5, will be between 3.6 degrees and 6 degrees, preferably equal to 5 degrees.

According to the disclosure, the extruder 1 comprises a stage 11 referred to as the “volumetric stage” within which the first thread 5 of the first screw 2 and the second thread 6 of the second screw 3 are interpenetrating and conjugated with respect to one another in such a way as to form, on the one hand, between the barrel 4 and the first screw 2, along the first central axis X2, a first series of successive C-shaped closed chambers 7 and, on the other hand, between the barrel 4 and the second screw 3, along the second central axis X3, a second series of successive C-shaped closed chambers 8, so that the rotation of the first and second screws 2, 3 generates a positive displacement of the material captured by the first series of chambers 7 and of the material captured by the second series of chambers 8.

“Interpenetrating” means that, as can be clearly seen in FIGS. 1, 3, 5, 6, and 8, the first and second threads 5, 6 are arranged such that the crest 5C of the first thread 5 arrives substantially at the root 6R of the second thread 6, and conversely, the crest 6C of the second thread 6 arrives substantially at the root 5R of the first thread 5, so that the thread 5, 6 of each screw 2, 3 penetrates the channel 10, 9 defined by the thread 6, 5 of the other screw 3, 2 over the entire radial height of the channel 10, 9.

By way of indication, between the crest 5C, 6C of one thread and the root 6R, 5R of the other thread, a functional radial clearance JR1 is provided which is of course non-zero to ensure smooth relative movement of one screw 2 relative to the other screw 3, but which is, most importantly, preferably less than or equal to 0.3 mm to ensure volumetric operation without leakage.

“Conjugated” means that, as can be clearly seen in FIGS. 1, 3, 5, 6, and 8, the first thread 5 and the second thread 6 are arranged such that the full axial width of the first thread 5, in other words the axial width of the full section of the profile of the first thread 5, fills the axial width of the second channel 10 defined by the second thread 6 and delimited axially between two successive flanks 6F of the second thread 6 and, reciprocally, the full axial width of the second thread 6 fills the axial width of the first channel 9 defined by the first thread 5 and delimited axially between two successive flanks 5F of the first thread 5. Thus, the flanks 5F of the first thread substantially match the flanks 6F of the second thread and vice versa.

By way of indication, to ensure volumetric operation without leakage, a functional axial clearance JA1 of less than or equal to 0.3 mm may be provided between the flank 5F, 6F of one thread and the closest portion of the flank 6F, 5F of the other thread.

For the same reasons of operation and tightness in operation, a radial clearance JR2 will be provided between the crest 5C, 6C of the thread of the screw 2, 3 and the radially innermost portion of the wall of the barrel 4, with which the crest 5C, 6C in question of the thread interacts, which radial clearance JR2 is non-zero and, preferably, equal to or less than 0.1 mm, in particular in the volumetric stage 11.

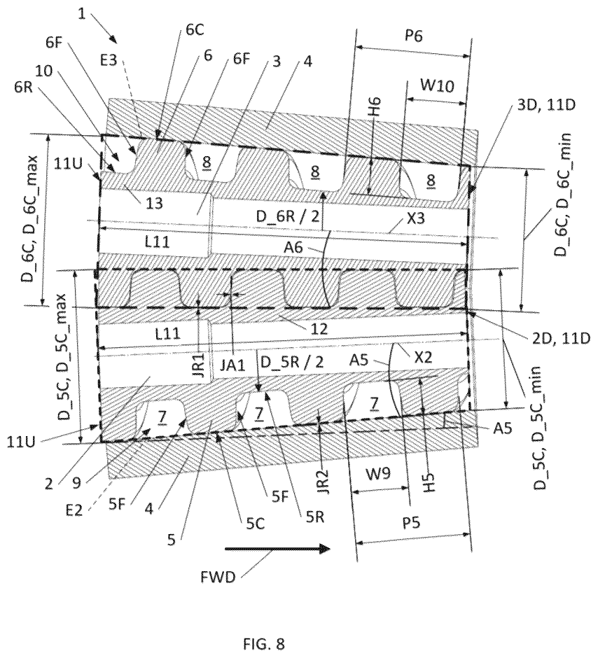

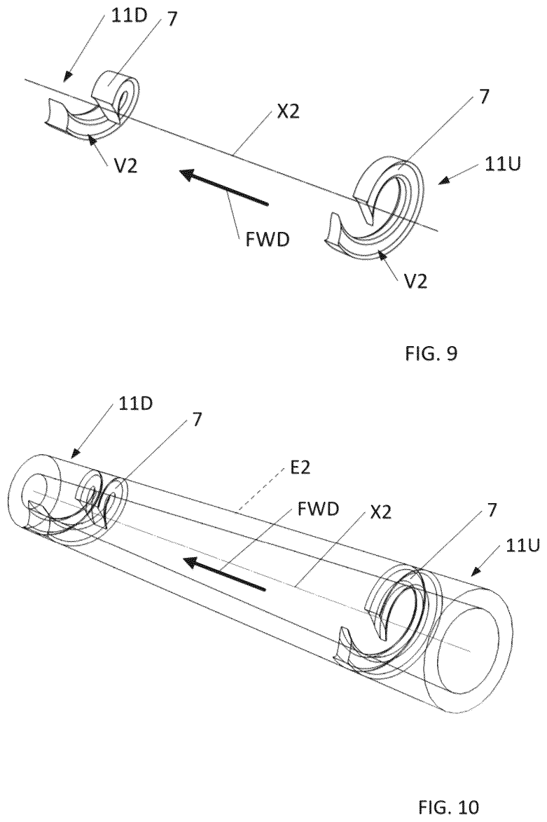

Advantageously, as shown schematically in FIGS. 8, 9, 10 and 11, each of the first and second series of chambers 7, 8 created in the volumetric stage 11 makes it possible firstly to capture the material in a first chamber 7, 8, forming the upstream access to the volumetric stage 11, which first chamber the rotation of the screw 2, 3 will close on the extruded material, in order to keep a corresponding volume of the extruded material captive inside the closed chamber, which is delimited by the C-shaped space between the screw 2, 3 and the barrel 4, then to convey the material downstream 2D, 3D, inside the closed chamber 7, 8, by gradually moving the chamber 7, 8 downstream 2D, 3D, along the central axis X2, X3, with an overall translational forward movement, denoted FWD here, by virtue of the rotational movement of the screw 2, 3.

By nature, the closed chambers 7, 8 of the same series of chambers are not in communication with one another, such that each unit volume of extruded material contained in a chamber 7 is isolated from the unit volume of extruded material contained in each of the other chambers 7, in particular in each of the adjacent chambers. Advantageously, the extruded material cannot therefore move back upstream 2U, 3U along the screw 2, 3, whatever the pressure prevailing at the downstream end 2D, 3D of the conical screw 2, 3, at the level where the last chamber 7, 8 of the succession of chambers 7, 8 opens onto the outlet of the extruder 1.

Thus, upon each complete rotational revolution of the screws 2, 3, the chambers 7, 8 shift downstream 2D, 3D, and therefore advance the extruded material, along the axis X2, X3 of each screw in question, by an axial distance which is equal to the pitch P5, P6 of the thread 5, 6 at the location in question.

The volume of extruded material which is delivered at the outlet of the extruder 1 upon each complete revolution of the screws 2, 3, in other words the total “displacement” of the extruder 1, thus corresponds to the sum of the unit volumes contained respectively in the last closed chamber 7 of the first succession of chambers 7, delimited by the first screw 2, and in the last closed chamber 8 of the second succession of chambers 8, delimited by the second screw 3, that is to say to the sum of the displacement of the first screw 2 and the displacement of the second screw 3.

This volumetric displacement of the extruder 1 makes it possible to precisely adjust the flow rate of the extruded material by adjusting the rotation speed of the screws 2, 3.

Advantageously, note that the fact that each screw 2, 3 generates, with the barrel 4, a multiplicity of chambers 7, 8 which follow one another axially, and which are separated from one another by the thread 5, 6 of the screw 2, 3 in question, makes it possible to globally reinforce the tightness of the extruder 1, and to reduce the sensitivity of this tightness to the wear of the screws 2, 3, by forming so many successive obstacles against the possibility of the extruded material moving back in the direction from downstream 2D, 3D to upstream 2U, 3U, along the barrel 4, between the barrel 4 and the screw 2, 3 in question.

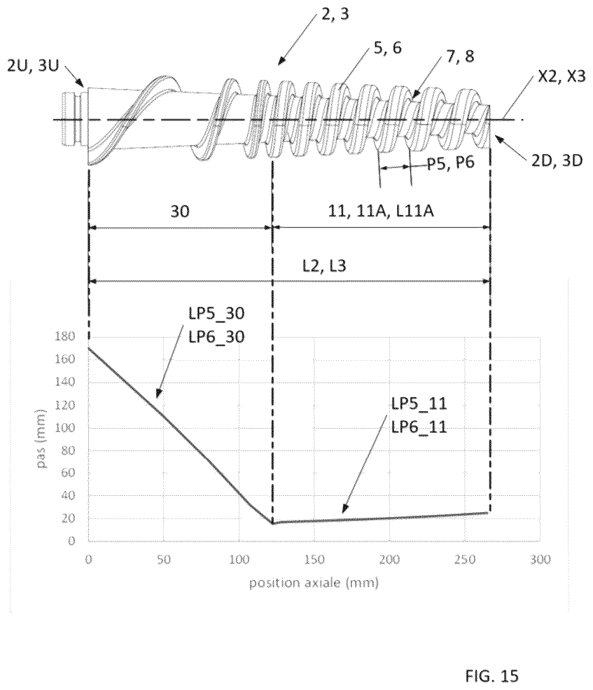

According to the disclosure, and as can be clearly seen in FIGS. 1, 3, 5, 6, 8 and 15, at least part of the volumetric stage 11, and more preferably all of the volumetric stage 11, forms a stage referred to as the “isochoric volumetric stage” 11A, within which: —the pitch P5 of the first thread 5 increases along the first central axis X2, in the upstream-downstream direction, as the crest diameter of the first thread D_5C decreases, according to a law referred to as the “first law of compensation” LP5_11 which allows the progressive increase in the pitch P5 of the first thread 5 to compensate for the conicity of the first screw 2 so that, in the isochoric volumetric stage 11A, the individual volume of each of the closed chambers 7 of the first series of closed chambers remains equal to the same predetermined constant nominal volume V2, referred to as the “first screw displacement” V2, with a maximum tolerance of +/−2%, preferably +/−1%, or even +/−0.5%, and
the pitch P6 of the second thread 6 increases along the second central axis X3, in the upstream-downstream direction, as the crest diameter of the second thread D_6C decreases, according to a law referred to as the “second law of compensation” LP6_11 which allows the progressive increase in the pitch P6 of the second thread 6 to compensate for the conicity of the second screw 3 so that, in the isochoric volumetric stage 11A, the individual volume of each of the closed chambers 8 of the second series of closed chambers remains equal to the same predetermined constant nominal volume V3, referred to as the “second screw displacement” V3, with a maximum tolerance of +/−2%, preferably +/−1%, or even +/−0.5%.

In other words, each of the closed chambers 7 delimited by the first screw 2 and the barrel 4 will have substantially or even exactly the same individual volume, substantially or even exactly equal to the individual volume of the neighboring chambers 7, and substantially or even exactly equal to the volume of the first screw displacement V2, that is to say in this case an individual volume equal to V2+/−2%, preferably equal to V2+/−1%, or even equal to V2+/−0.5%.

Likewise, each of the closed chambers 8 delimited by the second screw 3 and the barrel 4 will have substantially or even exactly the same individual volume, substantially or even exactly equal to the individual volume of the neighboring chambers 8, and substantially or even exactly equal to the volume of the second screw displacement V3, that is to say in this case an individual volume equal to V3+/−2%, preferably equal to V3+/−1%, or even equal to V3+/−0.5%.

From a dynamic point of view, the individual volume of each C-shaped closed chamber 7, 8 thus varies by less than 2%, less than 1%, or even less than 0.5% relative to the reference individual volume constituted by the screw displacement V2, V3, or is even equal to the reference individual volume, over all of the successive axial positions occupied by the closed chamber 7, 8 in question during its transfer from upstream to downstream of the isochoric volumetric stage 11A under the effect of the rotation of the screw 2, 3, and more preferably from the closure of the chamber 7, 8 at the upstream limit 11U of the volumetric stage 11 until the reopening of the chamber at the downstream limit 11D of the volumetric stage 11, in this case at the outlet of the extruder 1.

Equivalently, considering, rather than a dynamic vision of transfer of a chamber along the axis, a static vision of distribution of the chambers 7, 8 of the same series of chambers at a given moment, this amounts to saying that all of the closed chambers 7, 8 of the series of closed chambers 7, 8 delimited by the screw 2, 3 in question all have an individual volume that is substantially or even exactly identical, equal to the reference unit volume, to within +/−2%, preferably to within +/−1%, or even to within +/−0.5%.

Note that the arrangement proposed by the disclosure allows the extruder 1 to ensure a volume flow rate precision of less than or equal to 2%, even less than or equal to 1%, in other words to deliver a constant volume to within +/−2%, or even +/−1% per revolution of the screw, and to do so, preferably, for outlet pressures which may be between 200 bar and 500 bar, and for a volume flow rate of between 1 dm³/min and 6 dm³/min.

Preferably, the first screw displacement V2 is equal to the second screw displacement V3.

Preferably, the first screw displacement V2 and the second screw displacement V3 are each between 8 cm³ and 50 cm³, for example between 10 cm³ and 30 cm³, in particular between 10 cm³ and 20 cm³.

As stated above, the pitch P5 of the first thread 5 increases progressively, in the isochoric volumetric stage 11A, and more preferentially over the entire volumetric stage 11, along the first central axis X2 of the first screw 2, in the direction from upstream to downstream, as the diameter of the first screw 2 decreases, such that the pitch P5 is strictly greater at the downstream end 11D of the volumetric stage of the first screw 2, at the last chamber 7 forming the outlet chamber of the first screw 2, than the pitch P5 is at the upstream end 11U of the volumetric stage of the first screw 2, at the first chamber 7 forming the inlet chamber.

This increase in the pitch P5 of the first thread 5 is preferably monotonic, and more preferably linear, along the central axis X2, between on the one hand the value of the pitch P5 considered at the upstream end of the isochoric volumetric stage 11A, in this case the upstream end 11U of the volumetric stage 11, a value referred to as the “inlet pitch” P5_in, and on the other hand the value of the pitch P5, a higher value, considered at the downstream end of the isochoric volumetric stage 11A, in this case the downstream end 11D of the volumetric stage 11, a value referred to as the “outlet pitch” P5_out.

This variation in the pitch P5 of the first thread 5, in this case a continuous increase in the pitch P5 along the central axis X2, over the entire isochoric volumetric stage 11A, and more preferably over the entire volumetric stage 11, of the first screw 2, makes it possible to gradually increase the axial width W9 of the channel 9 defined by the first thread 5, as can be clearly seen in FIGS. 1, 2, 3, 8, 9 and 11, so as to compensate for the corresponding variation, in this case a continuous decrease, in the diameter of the first screw 2, in this instance a decrease which affects at least the crest diameter of the first thread D_5C, and preferably also the root diameter of the first thread D_5R, in order to keep the individual volume of each closed chamber 7 substantially or even exactly constant, while the chamber 7 is gradually transferred downstream by the rotational movement of the first screw 2.

In other words, the first channel 9 defined by the thread 5 of the first screw has, in the isochoric volumetric stage 11A, and preferably over the entire volumetric stage 11, a pitch P5 and a width W9 which increase gradually along the central axis X2, and more particularly which increase continuously according to an increasing function of the distance travelled along the central axis X2, so that each substantially annular portion of the first channel 9 which is delimited simultaneously by the first screw 2, by the inner wall of the barrel 4 (or, equivalently, by the frustoconical envelope E2), and by the thread 6 of the second screw 3 which closes off the ends of the portion of the first channel 9, such that the portion of the first channel 9 forms one of the C-shaped closed chambers 7, has a volume which remains unchanged when the chamber 7 moves from upstream to downstream under the effect of the joint rotation of the first and second screws 2, 3, and, at each given instant, which is equal to the volume of the neighboring closed chambers 7 of the same series of closed chambers 7.

The above considerations relating to the variation in the pitch P5 of the first thread 5, and therefore in the axial width W9 of the first channel 9, of course apply mutatis mutandis to the pitch P6 of the second thread 6 and the axial width W10 of the second channel 10, which, similarly, increase monotonically, along the second central axis X3, such that the pitch P6 of the second thread evolves between a minimum value corresponding to an inlet pitch P6_in at the upstream end of the isochoric volumetric stage 11A, which preferably coincides with the upstream end 11U of the volumetric stage 11, and a maximum value corresponding to an outlet pitch P6_out at the downstream end of the isochoric volumetric stage 11A, which preferably coincides with the downstream end 11D of the volumetric stage 11. Thus, the individual volume of each closed chamber 8 is kept substantially constant.

In all cases, to ensure smooth engagement of the first and second screws 2, 3, the pitch P5 of the first thread 5 is equal to the pitch P6 of the second thread, at each abscissa considered along the bisector of the angle at the apex which is formed by the intersection of the first central axis X2 and the second central axis X3.

Naturally, as can be clearly seen in FIGS. 2, 4, 5, 6, 8 and 15, as is the case for the axial widths W9, W10 of the channels 9, 10, that is to say of the hollow portions of the first and second threads 5, 6, the axial width of the solid portion of the profile of the first thread 5 increases with the pitch P5 of the first thread 5, and likewise for the axial width of the solid portion of the profile of the second thread 6 which increases with the pitch P6 of the second thread 6, such that the first and second threads 5, 6 are conjugated along the screws 2, 3, and thus maintain the tightness of the chambers 7, 8, while each occupying the entire width of the channel 10, 9 delimited by the thread 6, 5 of the other screw. In other words, in the isochoric volumetric stage 11A, and more preferably in the whole of the volumetric stage 11, each of the first and second threads 5, 6 simultaneously increases in pitch P5 and thickens in profile, along the central axis X2, X3, as the diameter of its conical screw 2, 3 decreases.

Preferably, the first law of compensation LP5_11 is an increasing quadratic function of the axial abscissa value in question along the first central axis X2.

Preferably, respectively, the second law of compensation LP6_11 is an increasing quadratic function of the axial abscissa value in question along the second central axis X3.

Advantageously, the first law of compensation LP5_11 and the second law of compensation LP6_11 may be expressed in the form of a second-degree polynomial as a function of the axial abscissa.

Preferably, since the first and second screws 5, 6 are the image of one another, the first law of compensation LP5_11 and the second law of compensation LP6_11 will be identical.

The advantage of quadratic functions is that it is possible for an increase in the pitch P5, P6 of the thread 5, 6 to compensate for a decrease in surface area, which is therefore two-dimensional, and which is linked to a decrease in both the crest diameter D_5C, D_6C of the thread 5, 6 and the root diameter D_5R, D_6R of the thread 5, 6.

To be specific, preferably, in the isochoric volumetric stage 11A, and more preferably in the entire volumetric stage 11, the core 12 of the first screw 2 and the crest of the thread 5 of this same first screw 2 narrow jointly, each according to an angle of conicity, and more preferably according to the same angle of conicity A5, such that they therefore generally follow, in a radial sectional plane containing the central axis X2, parallel slopes.

In other words, preferably, at least in the volumetric stage 11, the root diameter of the first thread D_5R decreases according to the first angle of conicity A5, such that the height of the first thread H5 varies by less than 20% in the volumetric stage along the first central axis X2, preferably by less than 10%, and more preferably by less than 5%. For example, the height of the first thread H5 is constant along the first central axis X2.

Advantageously, this makes it possible to limit the axial expansion of the pitch P5 of the thread 5, upon each helical revolution of the thread, which is necessary to keep the screw displacement V2 constant, but also to maintain a significant first screw displacement V2 and good circulation of the material in the channel 9. Otherwise, it will be appreciated that if the height H5 of the first thread were to decrease, in particular decrease sharply, for example relative to a cylindrical core 12, then it would be necessary to considerably lengthen the pitch P5 of the thread 5 to keep the displacement V2 constant, which would require lengthening the screw 2 and would potentially be detrimental to the tightness of the chambers 7.

By way of indication, it is for example possible to maintain, in particular in the volumetric stage 11, a thread pitch P5 which is less than the smallest crest diameter D_5C_min of the thread 5 in the volumetric stage 11.

Likewise, in the isochoric volumetric stage 11A, and more preferably in the entire volumetric stage 11, the core 13 of the second screw 3 and the crest of the thread 6 of this same second screw 3 narrow jointly, each according to an angle of conicity, preferably according to the same angle of conicity A6, so as to generally follow, in a radial sectional plane containing the central axis X2, parallel slopes.

Thus, the crest diameter D_5C, D_6C of the thread 5, 6 of each of the first and second screws 2, 3, i.e. the outside diameter of the screw 2, 3, and the root diameter D_5R, D_6R of the thread 5, 6, i.e. the inside diameter of the screw 2, 3, decrease continuously along the central axis X2, X3 of the screw 2, 3 in question, according to the same predetermined angle of conicity A5, A6, while the pitch P5, P6 of the thread 5, 6 increases continuously, in order to compensate for the joint decrease in the thread root diameter D_5R, D_6R and the thread crest diameter D_5C, D_6C, such that the successive closed chambers 7, 8 delimited by the screw 2, 3 in question each have an individual volume that is substantially constant from one chamber 7, 8 to the next, along the central axis X2, X3.

Thus, the thread height H5 of the first conical screw 2, referred to as the “first thread height H5” is preferably constant along the central axis X2 of the first conical screw 2, at least in the volumetric stage 11.

The same will preferably apply to the thread height H6 of the second conical screw 3.

Usually, the thread height H5 of the first screw 2 designates, as can be seen in FIG. 8, the distance which separates the midpoint of the root 5R of the first channel 9, considered at mid-distance axially from the two flanks 5F which border the channel, on the one hand, from the generatrix line which is tangent to the crests 5C of the first thread bordering the first channel 9, in other words from the straight line corresponding to the intersection of the frustoconical envelope E2 with the radial sectional plane, on the other hand. In other words, the thread height H5 is the length of the straight line segment perpendicular to the generatrix of the frustoconical envelope E2 and passing through the midpoint of the root 5R of the first channel 9.

The same applies to the height H6 of the thread 6 of the second screw 3, considered perpendicular to the frustoconical envelope E3.

However, to facilitate calculation in the following, the projection H5′, H6′ of the thread height H5, H6 in a plane normal to the central axis X2, X3 of the screw 2, 3 in question may also be considered.

Preferably, in the volumetric stage 11, whatever the angular position which is adopted respectively by each of the first and second screws 2, 3 about its central axis X2, X3 during the counter-rotating movement of the first and second screws 2, 3, the number of chambers 7 of the first series, which are simultaneously in a closed state, and the number of chambers 8 of the second series, which are simultaneously in a closed state, is equal to or greater than four, or even equal to or greater than five, lower limit, and preferably less than or equal to twenty, or even less than or equal to twelve, upper limit, for example between four and ten, or between five and eight.

The inventors in fact found that it was necessary to provide an axial succession of several chambers 7, 8 along the same screw 2, 3, in this case at least four, or even at least five chambers, to obtain satisfactory tightness, and therefore satisfactory volumetric operation, including in the presence of high pressures at the outlet of the extruder 1.

Conversely, the inventors also found that it was preferable to limit the number of chambers 7, 8 along the same screw 2, 3, and more generally the length L2, L3 of the screw 2, 3, typically by providing less than twenty, less than twelve, or even less than ten chambers along the same screw, in order in particular to prevent the risk of working the material too much, because excessive working would lead to excessive heating of the material, potentially detrimental to the material, such that the use of long screws 2, 3 with a higher number of chambers 7, 8 would require a preventive reduction in the rotation speed of the screws 2, 3, thus resulting in a limitation of the maximum working flow rate of the extruder 1.

Furthermore, limiting the length L2, L3 of the screws 2, 3, along with the number of chambers, reduces the resistance torque opposed by the material, and therefore the driving torque required to drive the screws 2, 3, which makes it possible to limit energy consumption while ensuring good efficiency, and in particular a good mass flow rate, of the extruder 1.

Note that the abovementioned dimensioning is particularly suitable for the extrusion of a rubber-based material, since the short screw length limits the residence time of the extruded material in the extruder 1, during which time the extruded material is exposed to the work of the screws 2, 3. This advantageously prevents overheating and therefore damage to the rubber-based material.

Note also that an extruder 1 according to the disclosure, when it is designed for the extrusion of a rubber-based material, does not require a significant screw length L2, L3 to ensure satisfactory tightness, and in particular can manage with an axial screw length L2, L3, more particularly a threaded axial length, which represents between 4 times and 10 times the maximum diameter of the screws 2, 3, unlike known extruders intended for thermoplastic materials and which, owing to the significant fluidity of such thermoplastic materials, must have a great length, typically of the order of 40 times the maximum diameter of the screw.

The extruder 1 according to the disclosure may thus be much shorter and lighter than known extruders, while still having a satisfactory volumetric displacement.

The length L3 of the second screw 3, which in this case corresponds to the total threaded length of the second screw 3, is advantageously equal to the length L2 of the first screw 2, which in this case corresponds to the total threaded length of the first screw 2.

According to a preferred feature which may constitute an disclosure in its own right, the extruder 1 comprises a stage referred to as the “feed stage” 30 which precedes the volumetric stage 11 and within which:
the first thread 5 is arranged such that, as the crest diameter D_5C of the first thread 5 decreases along the first central axis X2, in the upstream-downstream direction, according to the first angle of conicity A5, the pitch P5 of the first thread 5 also decreases, along the first central axis X2, in the upstream-downstream direction, according to a law referred to as the “first law of compression” LP5_30, in such a way as to promote compression of the material as it approaches the volumetric stage 11, and
the second thread 6 is arranged such that, as the crest diameter D_6C of the second thread 6 decreases along the second central axis X3, in the upstream-downstream direction, according to the second angle of conicity A6, the pitch P6 of the second thread 6 also decreases, along the second central axis X3, in the upstream-downstream direction, according to a law referred to as the “second law of compression” LP6_30, in such a way as to promote compression of the material as it approaches the volumetric stage 11.

Advantageously, the feed stage 30 makes it possible to receive the material, to work it and to pre-compress it in order to ensure the feeding of the volumetric stage, and thus on the one hand to ensure good filling of the first chamber 7, 8 of each screw 2, which makes it possible to optimize the effective displacement V2, V3 of each screw 2, 3, and on the other hand to limit the pressure gradient between the upstream and downstream of the volumetric stage 11, which prevents leaks and prevents material from moving back in the opposite direction to the desired forward movement FWD.

Note that, advantageously, the first screw 2 and the second screw 3 interact in a non-volumetric manner within the feed stage 30, which in particular allows the use of an extended thread 5, 6 pitch P5, P6, and therefore very wide channels 9, 10, which facilitates the insertion and swallowing of the material in the extruder 1, in particular when the material reaches the extruder in the form of a continuous strip.

Preferably, the smallest pitch P5, P6 of each screw 2, 3 considered in the feed stage 30 will be strictly greater than the longest pitch P5, P6 of this same screw 2, 3 considered in the volumetric stage 11, and more particularly in the isochoric volumetric stage 11A.

As an indication, and always with the aim of maintaining wide channels which promote swallowing of the material, the initial pitch P5, P6 in the feed stage 30 will preferably be equal to or greater than 0.5 times the diameter D_5C, D_6C of the crest of the thread 5, 6 considered at the upstream end of the feed stage 30.

Of course, it will be possible to provide in the barrel 4, opposite the feed stage 30, an intake port, possibly provided with a hopper, to allow the material to enter the barrel 4.

According to a possible variant embodiment, shown in FIGS. 1, 2 and 15, the first screw 2 and the second screw 3 may be single-threaded in the feed stage 30, and more preferably both in the feed stage 30 and in the volumetric stage 11.

Advantageously, it is thus possible to have single screw threads which extend continuously, but adapting their pitch P5, P6, through the feed stage 30 then the volumetric stage 11 of each screw 2, 3.

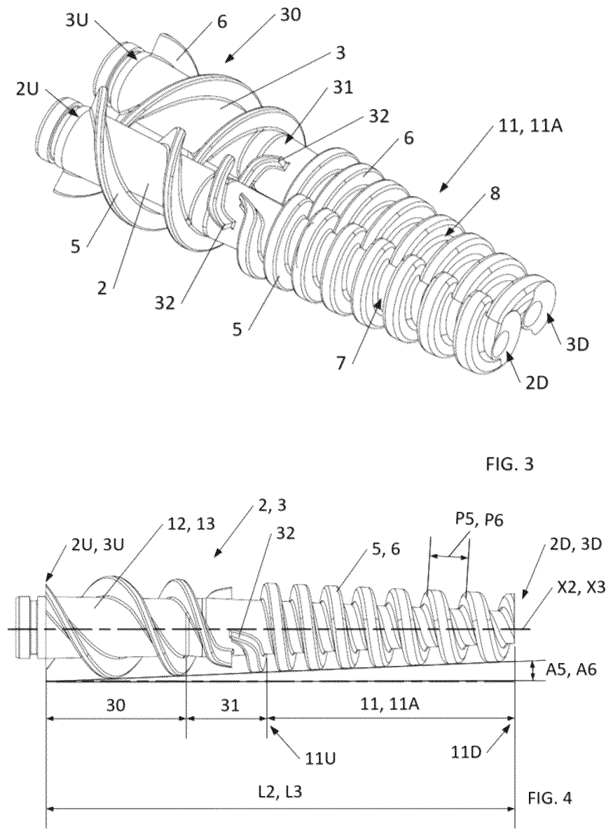

However, preferably, according to another variant embodiment, shown in FIGS. 3 and 4, in the feed stage 30, the first screw 2 and the second screw 3 are both multi-threaded, preferably double-threaded, such that the first thread 5 and the second thread 6 each comprise at least two screw threads which cover the same common axial extent and which are angularly offset from one another around the central axis X2, X3 of the screw 2, 3 in question.

These multiple screw threads in the feed stage 30 make it possible in particular to facilitate gripping of the material, in particular when it is supplied in the form of a strip, and its swallowing by the screws 2, 3.

This arrangement also improves the working of the material and its increase in pressure to promote feeding of the volumetric stage 11 located directly downstream of the feed stage 30.

Conversely, preferably, the first screw 2 and the second screw 3 are each, in the volumetric stage 11, single-threaded.

The screws 2, 3 may then have a transition zone 31 between the feed stage 30 and the volumetric stage 11, making it possible to go from multi-threaded upstream to single-threaded downstream, and where appropriate to go from one core geometry 12, 13 to another core geometry 12, 13, for example to adapt the screw thread root diameter D_5R, D_6R and/or the angle of conicity of the core 12, 13.

To be specific, note that, preferably, the core 12 of the first screw 2 has, in the feed stage 30, a straight cylindrical shape or a frustoconical shape the angle of conicity of which is strictly smaller than the first angle of conicity A5.

Respectively, the core 13 of the second screw 3 preferably has, in the feed stage 30, a straight cylindrical shape or a frustoconical shape the angle of conicity of which is strictly smaller than the second angle of conicity A6.

Such an arrangement advantageously makes it possible to maintain a relatively large screw thread root diameter D_5R, D_6R in the feed stage 30, which makes it possible to transmit a high driving torque to the screws 2, 3, and to keep a “diameter reserve” from which it will then be possible to proceed with the frustoconical reduction of the core 12, 13 in the isochoric volumetric stage 11A, without the risk of structurally weakening the screws 2, 3 too much.

Furthermore, a low or even zero angle of conicity of the core 12, 13 in the feed stage 30 facilitates the reduction in the volume of the channels 9, 10 under the effect of the reduction in the pitch P5, P6 of the thread 5, 6, which therefore promotes compression of the material and therefore feeding of the volumetric stage 11.

In the transition zone 31, as can be seen in FIGS. 3 and 4, the multiple screw threads of the feed stage 30 may end in the form of spouts 32, which open the channels 9, 10 to allow the material to enter the chambers 7, 8 of the volumetric stage 11.

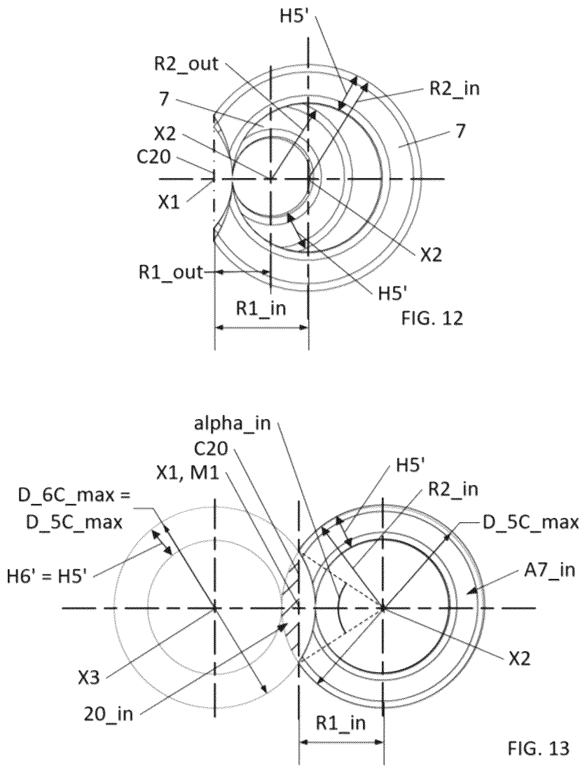

In practice, the respective isochoric volumetric stages 11A of the first and second conical screws 2, 3 may be dimensioned according to the method below, and with reference to FIGS. 11, 12 and 13.

Simply for the sake of brevity, only the dimensioning of the first conical screw 2 will be described, given that the dimensioning of the second conical screw 3 will be performed in a similar manner.

In absolute terms, it would be possible to provide within the volumetric stage 11, in particular in an upstream axial portion of the volumetric stage 11 preceding the isochoric volumetric stage 11A, closed chambers 7, 8 in which no increase in the pitch P5, P6 would be provided, in particular to initially obtain a reinforced compression effect, within the volumetric stage 11, between the first chamber and the second chamber of the series of chambers 7, 8 in question, after filling of the first chamber by the feed stage 30. However, for convenience in the description, a preferred variant embodiment will preferably be considered below, in which the entire volumetric stage 11 is concerned by the law of compensation LP5_11, LP6_11, in other words the isochoric volumetric stage 11A extends to the entire volumetric stage 11, over the entire axial extent of the latter, such that the upstream and downstream axial limits of the isochoric volumetric stage 11A coincide with the upstream 11U and downstream 11D limits of the volumetric stage 11.

“Large outside diameter” D_5C_max, D_6C_max will designate the crest diameter of the thread 5, 6 of the screw 2, 3, considered at the upstream end 11U of the isochoric volumetric stage 11A, which thus forms the diameter of the large base, which is circular, of the frustoconical envelope E2 of the isochoric volumetric stage 11A.

Likewise, “small outside diameter” D_5C_min, D_6C_min, which is strictly smaller than the large outside diameter D_5C_max, D_6C_max, will designate the crest diameter of the thread 5, 6 of the screw 2, 3, considered at the downstream end 11D of the isochoric volumetric stage 11A, which thus forms the diameter of the small base, which is circular, of the frustoconical envelope E2 of the isochoric volumetric stage 11A.

Advantageously, the large outside diameter D_5C_max of the first screw 2 will be equal to the large outside diameter D_6C_max of the second screw 3, and the small outside diameter D_5C_min of the first screw 2 will be equal to the small outside diameter D_6C_min of the second screw 3.

To determine the law of compensation LP5_11, the radius of the crest of the thread to be used to obtain the desired displacement V2 will first be determined, at several different abscissas along the isochoric volumetric stage 11A, and more preferably at least at the upstream end 11U and at the downstream end 11D of the volumetric stage 11A, and preferably at one or more additional abscissas between these ends, then the points thus defined will be interpolated by means of a second-degree polynomial law, which will constitute the law of compensation LP5_11 making it possible to define the radius of the crest of the thread 5 at any abscissa of the isochoric volumetric stage 11A.

For this purpose, the displacement V2 of the first screw 2, in other words the volume of extruded material that the screw 2 is to expel each time the screw 2 performs a complete rotational revolution about its central axis X2, will first be decided. This displacement V2 corresponds in practice to the individual volume V2, which is unchanging, of the various C-shaped chambers 7 of the first series of closed chambers 7. The closed chambers 7 correspond to the various portions of the first channel 9 which follow one another along the first central axis X2 and which are each, on the one hand, located between the screw 2 and the inner wall of the barrel 4, and on the other hand closed by the second thread 6 of the other screw 3 which penetrates the first thread 5 in such a way as to locally close off the first channel 9.

Reference is then made to the frustoconical envelope E2 of the isochoric volumetric stage 11A of the first screw 2 to calculate:
on the one hand the inlet radius R2_in, which corresponds to the radius of the crest 5C of the first thread 5 at the upstream end 11U of the isochoric volumetric stage 11A, and which is therefore equal to half the large outside diameter D_5C_max, which corresponds to the diameter of the large base of the frustoconical envelope E2, and
on the other hand the outlet radius R2 out of the isochoric volumetric stage 11A, which corresponds to the radius of the crest 5C of the first thread 5 at the downstream end 11D of the isochoric volumetric stage 11A, and which is therefore equal to half the small outside diameter D_5C_min, which corresponds to the diameter of the small base of the frustoconical envelope E2.

To this End the Following are Considered:
the length L11A of the isochoric volumetric stage 11A, which is, like the displacement V2, chosen by the designer, the length L2 being measured along the first central axis X2, in other words along the straight line which carries the height of the frustoconical envelope E2 (and which therefore corresponds, in a sectional plane containing the first central axis X2, to the bisector of the angle at the apex of the frustoconical envelope E2),
the total length L_tot which corresponds to the height measured between the large base of the first frustoconical envelope E2 and the apex S2 of the cone of the first frustoconical envelope E2,
the angle of conicity A5 of the first screw 2, also chosen by the designer, preferably in the ranges of values indicated above.

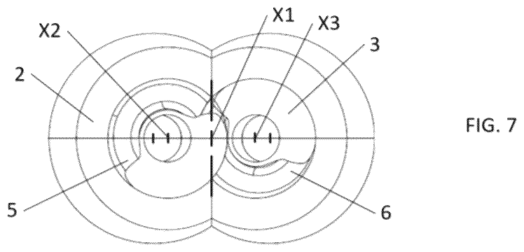

By simple trigonometry in a radial sectional plane containing the first central axis X2, and as shown in FIG. 7, we have:

$$R2\_in = L\_tot * tan ( A 5 )$$

$$R2\_out = ( L\_tot - L 2 ) * tan ( A 5 )$$

Knowing the chosen height H5 of the first thread 5, and therefore the projection H5′ of the height in a plane normal to the central axis X2, a value R1_in referred to as the “inlet apparent half-centre distance” is deduced therefrom which, in the plane of the large base of the first frustoconical envelope E2, which plane is normal to the first central axis X2, corresponds to the radial distance measured between, on the one hand, the central axis X2 and on the other hand the intersection M1 of the plane of the large base of the first frustoconical envelope E2 with a straight line X1 which corresponds to the median axis of the extruder 1 and which runs equidistant from the first central axis X2 and the second central axis X3, in the plane which contains both the first central axis X2 and the second central axis X3:

$$R1\_in = R2\_in - ( H {5}^{′} / 2 )$$

Likewise, in the plane of the small base of the first frustoconical envelope E2, the value R1_out of the outlet apparent half-centre distance is deduced:

$$R1\_out = R2\_out - ( H {5}^{′} / 2 )$$

In the plane of the large base of the first frustoconical envelope E2, the circular segment referred to as the “inlet truncation circular segment” 20_in is then identified, as shown in FIG. 13, which circular segment corresponds to the domain between on the one hand the arc chord C20 which passes through the intersection point M1 and which is perpendicular to the radius from the first central axis X2, and on the other hand the circular arc which is delimited by this arc chord C20 and the radius of which corresponds to the inlet radius R2_in.

The area A20_in of this inlet truncation circular segment 20_in is:

$$A20\_in = ½ * {( R2\_in )}^{2} * ( alpha\_in - sin ( alpha\_in ) )$$

where alpha_in represents the angle covered by the circular arc which delimits the inlet truncation circular segment 20_in, and is therefore:

$$alpha\_in = 2 * Arccos ( R 1 \_in / R 2 \_in )$$

Likewise, the area of the outlet truncation circular segment 20_out is considered:

$$A20\_out = ½ * {( R2\_out )}^{2} * ( alpha\_out - sin ( alpha\_out ) )$$

where alpha_out represents the angle covered by the circular arc which delimits the circular segment 20_out, and is therefore:

$$alpha\_out = 2 * Arccos ( R 1 \_out / R 2 \_out )$$

In the plane of the large base of the frustoconical shape E2, the area A7_in of the inlet chamber 7 is considered to be the difference between the area of the ring between the root 5R of the first thread 5 and the crest 5C of the first thread on the one hand, and the truncation area which is occupied by the thread 6 of the second screw 3 which penetrates the channel 9 of the first screw 2.

The truncation area, of substantially oval shape, is equal, in view of the symmetrical arrangement of the first screw 2 and second screw 3, to twice the area A20_in of the aforementioned inlet truncation circular segment 20_in.

Thus, since, at the upstream end 11U of the isochoric volumetric stage 11A, the crest 5C of the first thread is located at a radius which corresponds to the inlet radius R2_in, and the root 5R of the first thread at a radius located at a height H5′ set back from the crest 5C of the thread, the following is obtained:

$$A7\_in = π * [ {( R2\_in )}^{2} - {( R2\_in - H {5}^{′} )}^{2} ] - ( 2 * A20\_in )$$

Likewise, in the plane of the small base of the frustoconical shape E2, the area A7_out of the outlet chamber 7, at the downstream end 2D of the first screw may be defined:

$$A7\_out = π * [ {( R2\_out )}^{2} - {( R2\_out - H {5}^{′} )}^{2} ] - ( 2 * A20\_out )$$

The inlet pitch P5_in, considered at the axial abscissa of the upstream end 2U of the first screw, is then defined as being the ratio between the desired displacement V2 and the area A7 in of the inlet chamber as defined above:

$$P5\_in = V 2 / A7\_in .$$

Likewise, the outlet pitch P5_out at the downstream end 2D of the first screw 2 is defined as being the ratio between this same displacement V2, which is desired to be constant, and the area of the outlet chamber A7_out (which is, effectively, smaller than the area A7_in of the inlet chamber):

$$P5\_out = V 2 / A7\_out .$$

Once these two extreme pitch values P5_in, P5_out are fixed, the operation may be repeated on one or more intermediate abscissas, and a regression law may be applied to the point cloud obtained, preferably a second-degree polynomial law, which will define the law of compensation LP5_11.

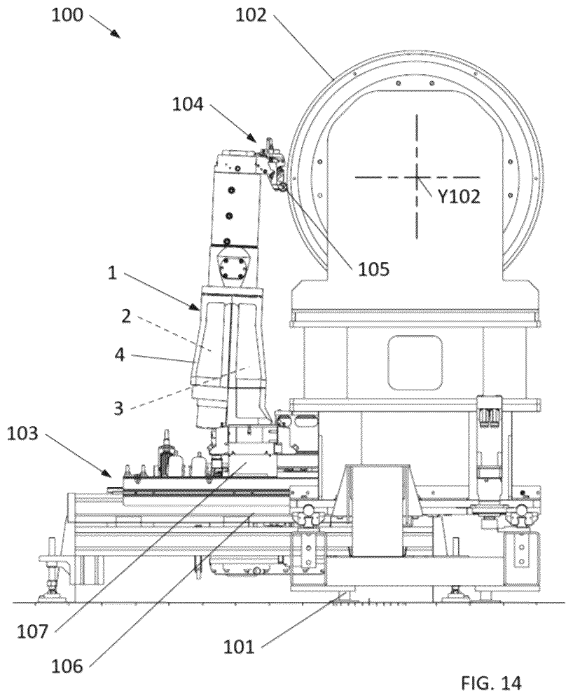

The disclosure of course also relates to a facility 100 which, as can be seen in FIG. 14, comprises an extruder 1 according to any one of the features described above, for delivering a material, preferably a rubber-based mixture.

The facility 100 comprises a base 101. This base advantageously forms a fixed frame of reference, and may correspond to the floor of the building housing the facility, or to a frame optionally fixed to the building.

The facility 100 also comprises a receiving support 102, such as a platform, a drum or a toroidal core, which is intended to receive the material extruded by the extruder 1.

The receiving support 102 is carried by the base 101, and may be mounted movably relative to the base 101. For example, in the case of a drum or a core forming a shape of revolution about a main axis Y102, the drum or the core may be mounted rotatably, preferably with motorized rotation, relative to the base 101, about the main axis Y102.

The facility 100 further comprises a robotic transport device 103, such as a Cartesian robot, as shown in FIG. 14, or an anthropomorphic robotic arm, which carries the extruder 1 and which is arranged in such a way as to be able, while the extruder 1 delivers the extruded material, to move the extruder 1 relative to the receiving support 102, in order to be able to lay the extruded material at different locations on the receiving support 102, in accordance with a predetermined desired arrangement.

As the extruder 1 according to the disclosure is lightweight and compact, this makes it possible to use the extruder 1 within a mobile laying head 104, mounted on the robotic transport device 103.

The robotic transport device 103 which carries the extruder 1 is interposed between the base 101 and the extruder 1 in such a way as to be able, while the extruder delivers the extruded material, to move the extruder relative to the base 101 and relative to the receiving support 102, in accordance with a movement which is advantageously distinct, and controllable separately, from any inherent movement which drives the receiving support 102 relative to the base 101.

Thus, the robotic transport device 103 will preferably be able to move the extruder 1 in translation along at least one axis, preferably at least two axes, or even three orthogonal axes, in order to position the extruder 1 in the frame of reference of the base 101.

The robotic transport device 103 may for example comprise for this purpose at least one, preferably two, motorized translation plates 106, 107, for example two horizontal motorized translation plates 106, 107, which cross one another perpendicularly.

Furthermore, the robotic transport device 103 may preferably move the extruder 1 in rotation about at least one axis, two axes, or even three axes to orient the extruder relative to the receiving support 102 in pitch, roll and/or yaw.

The laying head 104 will comprise a die, connected to the outlet of the extruder 1, in order to give the extruded material an appropriate shape, for example the shape of a flattened ribbon.

The laying head 104 may also comprise an applicator member 105, such as a press roller 105, arranged to press against the receiving support the extruded material which leaves the extruder 1 through the die.

The laying head 104, and more particularly the extruder 1, will preferably be supplied with a continuous strip of material coming from a storage unit or a production unit.

Lastly, the facility relates to an extrusion method implementing an extruder 1, or a facility 100, according to the disclosure.

In particular, the disclosure relates to the use of an extruder 1 according to the disclosure, or a facility 100 according to the disclosure, for extruding a rubber-based mixture, for example for manufacturing a part of a vehicle wheel tire, in particular a part of a pneumatic tire.

Thus, the extruder 1, and more generally the facility 100, may be arranged to lay a strip of raw rubber on a drum or on a toroidal core.

Preferably, on this occasion, the extruder 1 will provide a mass flow rate greater than or equal to 1 kg/min, for example between 1 kg/min and 6 kg/min, for a rotation speed of each of the first and second screws 2, 3 which is less than or equal to 300 rpm, for example between 10 rpm and 300 rpm.

These performance levels will preferably be achievable while the pressure at the outlet of the extruder, at the outlet of the last chamber 7, 8 and just at the inlet of the die, is between 150 bar and 500 bar, for a temperature of the material of between 80° C. and 150° C.

Of course, the disclosure is by no means limited simply to the variant embodiments described above, and a person skilled in the art could notably isolate or freely combine any of the aforementioned features, or replace them with equivalent features.

What is claimed is:

1. An extruder intended to extrude a material, said extruder comprising:
a barrel,
a first screw which is rotatably mounted in the barrel about a first central axis and which is provided with a first thread,
a second screw which is rotatably mounted in the barrel about a second central axis and which is provided with a second thread,
said first screw and second screw being counter-rotating and arranged such that the first thread and the second thread interact to convey the material from upstream to downstream in the barrel, and wherein
the first screw is conical, such that the crest diameter of the first thread decreases along the first central axis, in the upstream-downstream direction, according to a first predetermined angle of conicity,
the second screw is conical, such that the crest diameter of the second thread decreases along the second central axis, in the upstream-downstream direction, according to a second predetermined angle of conicity,
wherein said extruder comprises a volumetric stage within which the first thread of the first screw and the second thread of the second screw are interpenetrating and conjugated with respect to one another in such a way as to form, on the one hand, between the barrel and the first screw, along the first central axis, a first series of successive C-shaped closed chambers and, on the other hand, between the barrel and the second screw, along the second central axis (X3), a second series of successive C-shaped closed chambers, so that the rotation of the first and second screws generates a positive displacement of the material captured by the first series of chambers and of the material captured by the second series of chambers, and
wherein at least part of the volumetric stage forms a stage referred to as the “isochoric volumetric stage”, within which:
the pitch of the first thread increases along the first central axis, in the upstream-downstream direction, as the crest diameter of the first thread decreases, according to a first law of compensation which allows the progressive increase in the pitch of the first thread to compensate for the conicity of the first screw so that, in said isochoric volumetric stage, the individual volume of each of the closed chambers of the first series of closed chambers remains equal to the same first screw displacement, with a maximum tolerance of +/−2%, and
the pitch of the second thread increases along the second central axis, in the upstream-downstream direction, as the crest diameter of the second thread decreases, according to a second law of compensation which allows the progressive increase in the pitch of the second thread to compensate for the conicity of the second screw so that, in said isochoric volumetric stage, the individual volume of each of the closed chambers of the second series of closed chambers remains equal to the same predetermined second screw displacement, with a maximum tolerance of +/−2%.

2. The extruder according to claim 1, wherein the first law of compensation is an increasing quadratic function of the axial abscissa value in question along the first central axis and, respectively, the second law of compensation is an increasing quadratic function of the axial abscissa value in question along the second central axis.

3. The extruder according to claim 1, wherein the first angle of conicity and the second angle of conicity are each between 1.8 degrees and 3 degrees.

4. The extruder according to claim 1, wherein in the volumetric stage, whatever the angular position which is adopted respectively by each of the first and second screws about its central axis during the counter-rotating movement of said first and second screws, the number of chambers of the first series, which are simultaneously in a closed state, and the number of chambers of the second series, which are simultaneously in a closed state, is equal to or greater than four.

5. The extruder according to claim 1, wherein the first screw displacement and the second screw displacement are each between 8 cm³ and 50 cm³.

6. The extruder according to claim 1, wherein at least in the volumetric stage, the root diameter of the first thread decreases according to the first angle of conicity, such that the height of the first thread varies by less than 20% along the first central axis in the volumetric stage.

7. The extruder according to claim 1, further comprising a feed stage which precedes the volumetric stage and within which:
the first thread is arranged such that, as the crest diameter of said first thread decreases along the first central axis, in the upstream-downstream direction, according to the first angle of conicity, the pitch of said first thread also decreases, along the first central axis, in the upstream-downstream direction, according to a first law of compression, in such a way as to promote compression of the material as it approaches the volumetric stage, and
the second thread is arranged such that, as the crest diameter of the second thread decreases along the second central axis, in the upstream-downstream direction, according to the second angle of conicity, the pitch of the second thread also decreases, along the second central axis, in the upstream-downstream direction, according to a second law of compression, in such a way as to promote compression of the material as it approaches the volumetric stage.

8. The extruder according to claim 7, wherein the core of the first screw has, in the feed stage, a straight cylindrical shape or a frustoconical shape the angle of conicity of which is strictly smaller than the first angle of conicity and, respectively, the core of the second screw has, in the feed stage, a straight cylindrical shape or a frustoconical shape the angle of conicity of which is strictly smaller than the second angle of conicity.

9. The extruder according to claim 7, wherein, in the feed stage, the first screw and the second screw are both multi-threaded such that the first thread and the second thread each comprise at least two screw threads which cover the same common axial extent and which are angularly offset from one another around the central axis of the screw in question.

10. The extruder according to claim 1, wherein the first screw and the second screw are each, in the volumetric stage, single-threaded.

11. A facility comprising an extruder according to claim 1, for delivering a the facility also comprising a receiving support which is intended to receive the material extruded by the extruder, and a robotic transport device which carries the extruder and which is arranged in such a way as to be able, while the extruder delivers the material, to move said extruder relative to the receiving support, in order to be able to lay the extruded material at different locations on the receiving support, in accordance with a predetermined desired arrangement.

12. The use of an extruder according to any claim 1, for extruding a rubber-based mixture.

13. The use according to claim 12, wherein the extruder provides a mass flow rate greater than or equal to 1 kg/min for a rotation speed of each of the first and second screws which is less than or equal to 300 rpm.

14. The extruder according to claim 1, wherein the maximum tolerance of the first screw displacement is +/−0.5%.

15. The extruder according to claim 1, wherein the maximum tolerance of the second screw displacement is +/−0.5%.

16. The extruder according to claim 3, wherein the first and second angles of conicity are each in the range of 2.0 degrees to 2.5 degrees.

17. The extruder according to claim 4, wherein the number of chambers of the first series and the number of chambers of the second series are between five and eight.

18. The extruder according to claim 5, wherein the first screw displacement and the second screw displacement are each between 10 cm³ and 20 cm³.

19. The extruder according to claim 9, wherein the first screw and the second screw are both double-threaded.

20. The facility according to claim 11, wherein the receiving support is a platform, a drum, or a toroidal core.
